(19) United States
(12) Patent Application Publication
(10) Pub. No.: US 2024/0017206 A1
(43) Pub. Date: Jan. 18, 2024

(54) AN IMPROVED WET SCRUBBER

(71) Applicant: Edwards Limited, Burgess Hill, Sussex (GB)

(72) Inventors: Anna Victoria Howbrook, Burgess Hill, Sussex (GB); Gareth David Stanton, Burgess Hill, Sussex (GB); Mark James Attwood, Burgess Hill, Sussex (GB)

(21) Appl. No.: 18/250,878

(22) PCT Filed: Nov. 1, 2021
(86) PCT No.: PCT/GB2021/052822

§ 371 Date: Apr. 27, 2023

(30) Foreign Application Priority Data
Nov. 2, 2020 (GB) 2017350.6

(51) Int. Cl. B01D 53/18; B01D 47/10

(52) U.S. Cl. CPC B01D 53/185; B01D 47/10; B01D 2252/103; B01D 2257/406

(57) ABSTRACT

The present invention provides a wet scrubber for gas abatement, comprising a scrubbing vessel defining a chamber, a gas inlet for supplying a gas to be scrubbed, and a gas outlet for allowing the egress of a scrubbed gas; the inlet and outlet being in fluid communication with one another; one or more scrubbing fluid supply ports; the wet scrubber comprising at least one distribution element connected to a scrubbing fluid supply port for distributing a scrubbing fluid inside the chamber; wherein at least one said distribution element is a distribution plate comprising a cavity and a plurality of apertures arranged to allow scrubbing fluid to flow from the cavity.

### CROSS-REFERENCE OF RELATED APPLICATION

This application is a Section 371 National Stage Application of International Application No. PCT/GB2021/052822, filed Nov. 1, 2021, and published as WO 2022/090739A2 on May 5, 2022, the content of which is hereby incorporated by reference in its entirety and which claims priority of British Application No. 2017350.6, filed Nov. 2, 2020.

### FIELD

The present invention relates to wet scrubbers, apparatus for distributing a scrubbing solution, methods of scrubbing a gas and methods of designing a wet scrubber. More particularly, the present invention relates to wet scrubbers for scrubbing ammonia.

### BACKGROUND

Wet scrubbers are employed for the complete or partial removal of a component of a gas stream, e.g. a pollutant, so that the scrubbed gas stream can be released to the outside environment or directed to a downstream abatement system. A wet scrubber may be arranged, for example, to scrub ammonia from a gas stream.

Typically, a wet scrubber comprises a column into which a gas stream is directed whilst a counter current scrubbing solution is sprayed towards the gas stream to react with and remove a component from the gas stream. A column typically contains packing in the form of a plurality of pall rings or similar, and the scrubbing solution is distributed by a number of spray nozzles.

A wet scrubber may be positioned, for example, between the exhaust of a vacuum pump and an abatement system wherein ammonia and/or another component of the exhaust gas must be scrubbed from the exhaust gas stream.

The present inventors have found that known wet scrubbers which typically distribute a scrubbing solution via spray nozzles suffer from a number of disadvantages.

A first disadvantage of known wet scrubbers is that the volume of packing inside the column is limited because the packing must be located sufficiently below any spray nozzles to allow the spray nozzles to effectively distribute a scrubbing fluid. Therefore, packing material cannot be in close proximity to spray nozzles. Thus, the efficiency of the wet scrubber is compromised because the amount of packing material is limited. The size of a column must therefore be increased (in height and/or diameter), or a greater operational cost must be incurred, or a heat exchanger or similar must be employed if efficiency of scrubbing is to be improved. Often, the overall size of a wet scrubber is limited by its intended use and/or location.

A further disadvantage of known wet scrubbers is that they typically require a cyclone or vortex mechanism to direct fluid towards an outlet or drain due to rebounding spray or mist created at least in part by spray nozzles within the column. The size of a wet scrubber must therefore be large enough to house such a mechanism whilst allowing sufficient space for packing material and the head space below spray nozzles described above. A cyclone or vortex mechanism also increases operating costs.

A further disadvantage of known wet scrubbers is that their columns must have a circular axial cross section in order to provide an even distribution of scrubbing fluid by said spray nozzles. Efficiency would be compromised in columns having a non-circular axial cross section.

A yet further problem of known wet scrubbers is carryover, i.e. a build-up of undesirable particles in a gas outlet. This is particularly troublesome when a gas stream is subsequently directed to a downstream abatement system. For example, in ammonia abatement, the build-up of nitrous oxides may negatively affect the efficacy of a downstream abatement system if ammonia is not first removed or reduced to an acceptable level, with reduced carryover.

Accordingly, there is a need to improve the performance of wet scrubbers, particularly without increasing the size of a wet scrubber or its operating cost.

The present invention aims to address these and other problems with the prior art.

The discussion above is merely provided for general background information and is not intended to be used as an aid in determining the scope of the claimed subject matter. The claimed subject matter is not limited to implementations that solve any or all disadvantages noted in the background.

### SUMMARY

Accordingly, in a first aspect, the present invention provides a wet scrubber for gas abatement, comprising a scrubbing vessel defining a chamber, a gas inlet for supplying a gas to be scrubbed, and a gas outlet for allowing the egress of a scrubbed gas, the inlet and outlet being in fluid communication with one another; one or more scrubbing fluid supply ports; the wet scrubber comprising at least first and second distribution elements each connected to a scrubbing fluid supply port for distributing a scrubbing fluid inside the chamber; wherein the first distribution element is arranged to distribute virgin scrubbing fluid inside the chamber; and the second distribution element is arranged to distribute recirculated scrubbing fluid inside the chamber.

As used herein, the term “virgin scrubbing fluid” refers to fresh scrubbing fluid which is previously unused (e.g. has not been used to scrub).

As used herein, the term “recirculated scrubbing fluid” refers to scrubbing fluid which has initially entered the scrubbing vessel as virgin, i.e. previously unused, scrubbing fluid and is subsequently captured and redistributed within the scrubbing vessel via a distribution element arranged to distribute recirculated scrubbing fluid.

Providing a wet scrubber in accordance with the first aspect improves the performance of the wet scrubber because a gas to be scrubbed comes into contact with both virgin, i.e. previously unused, scrubbing fluid as well as recirculated scrubbing fluid. The output concentration of a contaminant of the gas to be scrubbed is thus improved. Improved performance is achieved without substantially increased operating costs, for example the cost of providing a greater volume of virgin scrubbing fluid. Also, improved performance is achieved without the need to increase the size of the wet scrubber.

The second distribution element may be fluidly located between the first distribution element and the gas inlet. Thus, a gas to be scrubbed first comes into contact with recirculated scrubbing fluid or a mixture of virgin and recirculated scrubbing fluids, and subsequently comes into contact with only virgin scrubbing fluid. The wet scrubber may be arranged such that scrubbing fluid flows counter currently to a gas to be scrubbed, which generally flows from the gas inlet towards the gas outlet in use. Arranging the wet scrubber such that scrubbing fluid flows counter currently to the gas to be scrubbed improves scrubbing. In embodiments, the wet scrubber is a substantially vertically extending column and the first distribution element is located higher than the second distribution element within the column.

At least one of the distribution elements may comprise a distribution plate. The distribution plate may comprise a cavity and a plurality of apertures arranged to allow scrubbing fluid to flow from the cavity. Preferably, the second distribution element comprises a distribution plate. In embodiments, the first and second distribution elements may both comprise distribution plates. In embodiments, the wet scrubber comprises more than two distribution elements and each distribution element comprises a distribution plate.

The scrubbing vessel may be a substantially vertically extending column, and the second distribution element may be located substantially in the lower half of the scrubbing vessel, preferably substantially in the lowermost third of the scrubbing vessel. In embodiments, the first distribution element is located substantially towards an upper end of the scrubbing vessel.

The wet scrubber may comprise one or more pumps configured to provide recirculated scrubbing fluid to a distribution element arranged to distribute recirculated scrubbing fluid. The wet scrubber may further comprise a reservoir for the collection of scrubbing fluid to be recirculated. Because a scrubbing fluid may not be saturated with a component, e.g. ammonia, after one pass, recirculating the scrubbing fluid may reduce the volume of virgin scrubbing fluid required for a scrubbing process. Scrubbing fluid may only be recirculated up to a concentration wherein the partial pressure of a contaminant is equal to the vapour pressure of that contaminant from the dissolved concentration of the contaminant in the recirculated scrubbing fluid.

In embodiments, the apertures of the or each distribution plate may be substantially uniformly spaced across a bottom surface of said distribution plate.

The scrubbing vessel may contain packing material, and the packing material may be substantially contiguous with at least one distribution plate. As used herein, the term “contiguous” refers to the packing material and a distribution plate touching one another or being in close proximity to one another. In embodiments, the wet scrubber comprises first and second distribution elements which are distribution plates and both distribution plates are substantially contiguous with the packing material. In embodiments, at least one said distribution plate is arranged such that it rests on top of packing material within the scrubbing vessel. In other words, the at least one distribution plate is supported by the packing material. In embodiments, the wet scrubber may comprise a substantially unoccupied space located between a distribution plate and the packing material. Such a space may be provided between the packing material and the top surface and/or the bottom surface of a distribution plate. In embodiments, a substantially unoccupied space may be provided between the bottom surface of a distribution plate and the packing material in order that scrubbing fluid may flow from the distribution plate and fall onto the packing material. The wet scrubber may comprise means for releasably or permanently fixing a distribution plate to an inner wall of the scrubbing vessel. For example, the scrubbing vessel may comprise an intrusion or an abutment, such as a supporting rim, on which a distribution plate rests in use. The supporting rim may extend around substantially the entire circumference of the inner wall of the scrubbing vessel. Alternatively, the supporting rim may comprise intervals or gaps.

In a further aspect, the present invention provides a wet scrubber for gas abatement, comprising a scrubbing vessel defining a chamber, a gas inlet for supplying a gas to be scrubbed, and a gas outlet for allowing the egress of a scrubbed gas; the inlet and outlet being in fluid communication with one another; one or more scrubbing fluid supply ports; the wet scrubber comprising at least one distribution element connected to a scrubbing fluid supply port for distributing a scrubbing fluid inside the chamber; wherein at least one said distribution element is a distribution plate comprising a cavity and a plurality of apertures arranged to allow scrubbing fluid to flow from the cavity.

Providing a wet scrubber in accordance with the further aspect improves the performance of the wet scrubber. In particular, providing a distribution plate may improve distribution of scrubbing fluid within the chamber of the scrubbing vessel compared to a wet scrubber comprising only spray nozzles. A distribution plate may produce less rebounding mist than a typical spray nozzle. Thus, a cyclone or vortex mechanism may not be required for managing the flow of fluid within the vessel. Typically, head space is required below a spray nozzle to allow a scrubbing fluid to be effectively distributed. Head space may not be required below a distribution plate. Therefore, the size of a wet scrubber can be minimised and the volume of a packing material, if present, can be maximised within the chamber to improve the performance of the wet scrubber without increasing operating costs.

A distribution plate may be arranged to distribute virgin or recirculated scrubbing fluid within the chamber of the scrubbing vessel.

The wet scrubber may comprise a plurality of distribution elements. In embodiments, the wet scrubber may comprise a first distribution element which comprises one or more spray nozzles and a second distribution element which comprises a distribution plate.

Preferably, the wet scrubber may comprise first and second distribution elements, wherein the first and second distribution elements are distribution plates.

Providing first and second distribution plates further improves the performance of the wet scrubber because the dimensions of the wet scrubber can be minimised and the volume of packing material, if present, can be maximised within the chamber.

A first distribution plate may be arranged to distribute virgin scrubbing fluid inside the chamber, and a second distribution plate may be arranged to distribute recirculated scrubbing fluid inside the chamber. In embodiments, first and second distribution plates may be arranged to distribute virgin scrubbing fluid inside the chamber.

Typically, the second distribution plate, which is arranged to distribute recirculated scrubbing fluid, is fluidly located between the first distribution plate and the gas inlet of the wet scrubber.

The apertures of the of each distribution plate may be substantially uniformly spaced across the bottom surface of the distribution plate. Thus, in use, scrubbing fluid is more evenly distributed within the chamber.

The scrubbing vessel may comprise packing material, wherein the packing material is substantially contiguous with the at least one distribution plate. In embodiments, a substantially unoccupied space may be provided between the packing material and a distribution plate.

Where the wet scrubber comprises first and second distribution elements which are distribution plates and the scrubbing vessel comprises packing material, preferably both distribution plates may be substantially contiguous with the packing material.

The wet scrubber may be arranged such that scrubbing fluid flows counter currently to a gas to be scrubbed, which generally flows from the gas inlet towards the gas outlet in use. The scrubbing vessel may be a substantially vertically extending column, wherein a first distribution plate is located towards the upper end of the scrubbing vessel and a second distribution plate is located substantially in the lower half, preferably the lowermost third, of the scrubbing vessel. In embodiments, a distribution plate which is arranged to distribute recirculated scrubbing fluid is located substantially in the lower half of the scrubbing vessel, preferably in the lowermost third of the scrubbing vessel. It has been found that positioning the recirculating distribution plate in the lower half of a column improves performance of the wet scrubber. It has also been found that positioning the recirculating distribution plate in the upper half of a column may decrease performance of the wet scrubber.

The wet scrubber may comprise a plurality of distribution elements wherein several said distribution elements are distribution plates. In embodiments, the wet scrubber may comprise a plurality of distribution elements wherein at least one said distribution element is a spray nozzle and one or more of the distribution elements are distribution plates.

In some embodiments, a spray nozzle is located towards a top end of the scrubbing vessel and one, optionally two, or optionally more than two distribution plates are arranged below said spray nozzle to form, together with packing material, a mufti-stage packed tower.

In embodiments, at least one distribution element may be configured to distribute a different scrubbing fluid to at least one other distribution element to provide a multi-stage treatment of a gas supplied to the wet scrubber. In embodiments, each distribution element may be configured to distribute a different scrubbing fluid to each other distribution element. For example, a wet scrubber may comprise three distribution elements: a first distribution element may be arranged to distribute an acidic and/or oxidising agent-containing solution; a second distribution element may be arranged to distribute a caustic and/or reducing agent-containing solution, e.g. sodium hydroxide; and a third distribution element may be arranged to distribute water.

Typically, in any or all of the above aspects, a distribution plate comprises a top surface, a bottom surface and a circumferential wall extending between the top and bottom surfaces and defining a cavity. The top and bottom surfaces of a distribution plate are typically substantially perpendicular to a longitudinal axis of the scrubbing vessel. In other words, the top and bottom surfaces of a distribution plate typically extend across substantially the diameter of the chamber defined by the scrubbing vessel. Typically, a distribution plate comprises a conduit which is arranged to be in fluid communication with a scrubbing fluid supply port. Typically, the conduit is located at the circumferential wall of a distribution plate.

In any or all of the above aspects, the or each distribution plate may comprise a circumferential wall which is contiguous with an internal wall of the scrubbing vessel. Alternatively, a space may be provided between the circumferential wall of the distribution plate and an internal wall of the scrubbing vessel.

In any or all of the above aspects, a virgin scrubbing fluid may comprise water. The water may be tap water or deionised water. In embodiments where a gas to be scrubbed is acidic, the water is preferably tap water. In any or all of the above aspects, a virgin scrubbing fluid may comprise an acidic or alkali fluid, and/or may comprise a reducing agent or oxidising agent, or a mixture thereof. In embodiments where the gas to be scrubbed comprises ammonia, the scrubbing fluid may comprise sulphuric acid. In embodiments, the virgin scrubbing fluid may comprise sodium or potassium hydroxide, or peroxide, for example, or a mixture thereof. A virgin scrubbing fluid may comprise water and an additive to reduce water consumption and maximise scrubbing efficiency.

In embodiments of any or all of the above aspects, the packing material of a scrubbing vessel may comprise a plurality of pall rings.

In embodiments of any or all of the above aspects, the wet scrubber may be free from means arranged to create a cyclone, vortex or similar within the chamber.

In embodiments of any or all of the above aspects, the scrubbing vessel comprises a column with a height of 2 metres or less, preferably 1500 mm or less, more preferably around 910 mm or less and the second distribution element is located at a height of between 125 mm and 450 mm from the bottom of the column, preferably between 125 mm and 358 mm from the bottom of the column, more preferably around 250 mm from the bottom of the column, and yet more preferably 253 mm from the bottom of the column. In alternative embodiments, the column has a height of around 756 mm and the second distribution element is located at a height of between 125 mm and 450 mm from the bottom of the column, preferably between 125 mm and 358 mm from the bottom of the column, more preferably around 250 mm from the bottom of the column, and yet more preferably 253 mm from the bottom of the column. For example, a “sub fab” arrangement underneath a semiconductor fabrication system includes a wet scrubber comprising a scrubbing vessel having a column with a height of 2 meters or less.

In embodiments of any or all of the above aspects, the column has an outer diameter of around 125 mm and an inner diameter of around 115 mm.

In embodiments of any or all of the above aspects, the or each distribution plate comprises cylinder having a height of around 50 mm and a diameter of around 115 mm.

In embodiments of any or all of the above aspects, virgin scrubbing fluid is supplied to the wet scrubber at a temperature of between around 1° C. and around 30° C. Preferably, scrubbing fluid is supplied to the wet scrubber at a temperature of between 1° C. and around 10° C. Typically, the scrubbing efficiency of the wet scrubber is improved as the temperature of the scrubbing fluid is minimised.

In embodiments of any or all of the above aspects, recirculated scrubbing fluid is supplied to the wet scrubber at a temperature which is lower, i.e. colder, than the temperature of virgin scrubbing fluid entering the scrubbing vessel or up to around 6° C. warmer than the temperature of virgin scrubbing fluid entering the scrubbing vessel.

In embodiments of any or all of the above aspects, virgin scrubbing fluid is supplied to the first distribution element at a temperature between around 7° C. and around 8° C., and at a pressure of between around 0.8 Bar and around 1 Bar. In embodiments, recirculated scrubbing fluid is supplied to the second distribution element at a temperature of around 9° C.

In embodiments of any or all of the above aspects, virgin scrubbing fluid is supplied to the wet scrubber at a flow rate of between around 0.5 litres per minute to around 10 litres per minute.

In embodiments of any of all of the above aspects, recirculated scrubbing fluid is supplied to the wet scrubber at a flow rate of between around 50 litres per hour to around 300 litres per hour.

In embodiments, the apertures of the or each distribution plate have a diameter which is sufficient to allow a selected flow rate of scrubbing fluid to effectively exit the distribution plate.

In embodiments of any or all of the above aspects, the apertures of a distribution plate may be substantially equal in diameter. In other embodiments, the apertures of a distribution plate may be substantially unequal in diameter.

In embodiments of any or all of the above aspects, the wet scrubber may be an ammonia wet scrubber configured to remove or reduce the amount of ammonia in a gas to be scrubbed. In embodiments, the wet scrubber is a pre scrubber and is located between a vacuum pump and a downstream abatement system to reduce the amount of ammonia entering the downstream abatement system, and therefore the amount of nitrous oxides formed in the downstream abatement system.

In embodiments of any or all of the above aspects, the wet scrubber is adapted to scrub ammonia from a gas stream, and ammonia is supplied to the wet scrubber at a flow rate of between around 2 litres per minute (lpm) and around 40 litres per minute. In embodiments, ammonia is supplied to the wet scrubber in between around 0 lpm and around 1200 lpm of dilution nitrogen. In embodiments, ammonia is supplied to the wet scrubber in between around 50 lpm and around 200 lpm. In embodiments, ammonia is supplied to the wet scrubber in around 150 lpm of dilution nitrogen.

In embodiments of any or all of the above aspects, the wet scrubber may be configured to remove or reduce substrates (from a waste gas stream) associated with epitaxial growth, for example epitaxial silicon growth, or other silicon or silicon-associated substrates. A waste gas stream associated with epitaxial silicon growth may typically contain a high amount of hydrogen, as well as other potentially toxic components such as dichiorosilane (SiCl₂H₂), trichiorosilane (SiCl₃H) and/or hydrogen chloride (HCl).

In embodiments, the wet scrubber may be configured to remove or reduce the amount of dichiorosilane (SiCl₂H₂), trichlorosilane (SiCl₃H) and/or hydrogen chloride (HCl) from a process gas.

In embodiments, the wet scrubber may be configured to remove or reduce the amount of a component having the following composition SiCl(x)H(4−x), where x=1 to 3, from a process gas.

As used herein, the term “epitaxial growth” refers to the growth of crystalline layers or films on a substrate.

In embodiments, the wet scrubber may be a pre scrubber.

In a further aspect, the invention provides a gas abatement system comprising a wet scrubber in accordance with any or all of the above aspects. A gas abatement system may further comprise a gas abatement unit. A gas abatement system may further comprise one or more pumps adapted to facilitate the flow of a gas to be abated into or through the gas abatement system. In embodiments, the gas abatement system may be adapted to abate ammonia from a gas stream.

In a further aspect, the present invention provides a distribution plate for a wet scrubber, the distribution plate comprising a top surface, a bottom surface and a circumferential wall connecting the top and bottom surfaces and defining a cavity; the circumferential wall comprising a conduit arranged to be in fluid communication with a scrubbing fluid supply port of a wet scrubber; the distribution plate further comprising one or more channels extending between the top and bottom surfaces; wherein the or each channel is arranged to allow, in use, fluid to pass therethrough from the top surface towards the bottom surface and vice versa; the bottom surface comprising a plurality of apertures arranged to allow a scrubbing fluid to flow from the cavity.

Thus, a scrubbing fluid may flow from the cavity through the apertures into the chamber of a wet scrubber. Separately, a fluid, for example gas flowing from the gas inlet towards the gas outlet or scrubbing fluid from an upstream distribution element, may flow through the or each channel of the distribution plate in either direction, i.e. from top to bottom or vice versa.

In embodiments, the distribution plate is arranged to distribute recirculated scrubbing fluid within the scrubbing vessel of a wet scrubber, and may be located below a distinct distribution element. In these embodiments, the or each channel is configured to allow fluid to flow from the top surface of the distribution plate towards the bottom surface, and gas to flow from the bottom surface of the distribution plate towards the top surface, i.e. towards a gas outlet, without either fluid being able to enter the cavity. Thus, in embodiments, the distribution plate may be arranged to distribute recirculated scrubbing fluid without the need to after the configuration of an existing wet scrubber. In other words, a distribution plate may be retrofitted within a wet scrubber. For example, a distribution plate may be fitted within the packed tower of an abatement system, wherein the packed tower is downstream of a combustion unit.

The or each channel may be bounded by a separating wall which is configured to separate said channel from the cavity. Thus, in use, the cavity is not in fluid communication with the or each channel.

The distribution plate may have a substantially circular axial cross section. Alternatively, the distribution plate may have a substantially non-circular axial cross section. The distribution plate may have an axial cross section which is shaped to correspond to the axial cross section of the chamber of a scrubbing vessel of a wet scrubber.

The distribution plate may comprise a plurality of channels. The distribution plate may comprise two, three, four or five channels. The distribution plate may comprises more than five channels. The or each channel may have a substantially circular axial cross section.

The diameter of the or each channel may be configured dependent on the expected fluid flow rates of a particular use. The or each channel should typically have a diameter which avoids a drop in pressure or blockage of a channel, whilst being small enough that the majority of the bottom surface of the distribution plate is available to comprise apertures to improve distribution of a scrubbing fluid.

The plurality of apertures may be substantially uniformly spaced across the bottom surface of the distribution plate. Thus, a scrubbing fluid may be more evenly distributed within a scrubbing vessel.

The diameter and/or depth of the distribution plate may be configured dependent on the expected fluid flow rates of a particular use.

In embodiments, the distribution plate may comprise a cylinder having a height of approximately 50 mm and a diameter of approximately 115 mm. The distribution plate may comprise five channels which each have a diameter of approximately 18 mm. The conduit of the circumferential wall of the distribution plate may have a ⅜″ bulkhead through which a scrubbing fluid is supplied, in use. Each of the plurality of apertures at the bottom surface may have a diameter of approximately 1.2 mm. In embodiments, the bottom surface may comprise between around 50 and around 300 apertures. For example, the bottom surface may comprise between around 80 and around 90 apertures, for example 88 apertures.

In embodiments, the distribution plate may comprise means for capturing scrubbing fluid which, in use, flows onto the top surface of the distribution plate. The distribution plate may be arranged to redistribute captured scrubbing fluid. In embodiments, the distribution plate may be arranged to distribute recirculated scrubbing fluid, and the distribution plate may be located within a wet scrubber below another distribution element. In these embodiments, the distribution plate which is arranged to distribute recirculated scrubbing fluid may comprise means for capturing scrubbing fluid which flows from the distribution element above it. The distribution plate may be configured such that captured scrubbing fluid is allowed to enter the cavity to be distributed via the plurality of apertures of the bottom surface of the distribution plate.

In alternative embodiments, the distribution plate may be arranged to facilitate the removal of captured scrubbing fluid from the wet scrubber. For example, the distribution plate may be connectable to a drain for draining scrubbing fluid which flows onto a top surface of the distribution plate. In embodiments, the scrubbing fluid distributed by a distribution plate may be configured to scrub within only a predetermined part of the scrubbing vessel. In these embodiments, a further distribution plate may be arranged to capture the scrubbing fluid flowing from an upstream distribution and remove the captured scrubbing fluid from the wet scrubber. The wet scrubber may be arranged to transport captured scrubbing fluid to a distinct part of a scrubbing or abatement system.

In embodiments, a distribution plate comprises one or more venturi scrubbers or the like. A venturi scrubber comprises a converging and diverging gas flow channel and a scrubbing fluid is injected into a throat of the venturi scrubber. The scrubbing fluid is atomized by turbulence in the throat, improving gas-liquid contact. The gas-liquid mixture then decelerates as it moves through the diverging section of the scrubber, causing additional particle-droplet impacts and agglomeration of the droplets. This aids soluble gas scrubbing as well as any particulate that may be suspended in the gas phase.

A venturi scrubber minimises or prevents water carryover which is otherwise detrimental to any subsequent abatement process. Water carryover may also cause blockage within a scrubbing or abatement system. In embodiments, one or more of the channels of a distribution plate comprises a venturi scrubber. In embodiments, a distribution plate comprises five channels at least one channel, preferably each channel, comprises a venturi scrubber. The diameter of the throat of a venturi scrubber is dependent on the pressure drop suitable for the use of the wet scrubber in which the distribution plate is located. In embodiments, there is an optimum liquid gas ratio for a venturi scrubber of around 10 gal/1000 ft³. For example, when 150 litres per minute of gas is split substantially evenly between the channels of a distribution plate comprises five channels, around 0.04 litres per minute of scrubbing fluid is required per venturi scrubber, where each channel of the distribution plate comprises a venturi scrubber.

In embodiments, the distribution plate comprises one or more venturi scrubbers. The distribution plate may comprise the or each venturi scrubber in place of the channels which extend therethrough. In embodiments, the distribution plate comprises five venturi scrubbers which are located between the top and bottom surfaces of the distribution plate.

In a further aspect, the present invention provides a method of scrubbing a gas, comprising the steps of:
a. directing a gas to be scrubbed into a wet scrubber;
b. treating the gas with virgin scrubbing fluid and recirculated scrubbing fluid as the gas passes from a gas inlet towards a gas outlet of the wet scrubber.

A gas to be scrubbed may be contacted first by recirculated scrubbing fluid or a mixture of recirculated and virgin scrubbing fluids, and subsequently only by virgin scrubbing fluid as the gas passes from a gas inlet towards a gas outlet of the wet scrubber.

In embodiments, the flow rate of a scrubbing fluid into a distribution element is determined by achieving an optimum gas capture whilst minimising vapour pressure.
a. In a further aspect, the invention provides a method of designing a wet scrubber having a scrubbing vessel defining a chamber, a gas inlet, and a gas outlet, one or more scrubbing fluid supply ports and one or more scrubbing fluid distribution elements, wherein at least one said distribution element is a distribution plate arranged to distribute recirculated scrubbing fluid inside the chamber, the method comprising the steps of: determining the configuration and dimensions of the scrubbing vessel, gas inlet, gas outlet and scrubbing fluid supply ports;
b. determining the content and flow rate of gas to be scrubbed into the gas inlet;
c. determining the content and flow rate of scrubbing fluid through the one or more distribution elements; and
d. arranging the or each distribution plate within the scrubbing vessel such that the output concentration of a contaminant to be scrubbed from the gas is substantially minimised.

In embodiments, the optimum position of a distribution plate is dependent on the temperature of scrubbing fluid flowing into the wet scrubber. In embodiments, a first distribution plate is arranged to distribute virgin scrubbing fluid and a second distribution plate is arranged to distribute recirculated scrubbing fluid. Typically, if the recirculating scrubbing fluid temperature is increased relative to the virgin scrubbing fluid temperature, the recirculated scrubbing fluid removes a smaller amount of a contaminant from a gas. This is because a contaminant vapour pressure is greater at a higher temperature. Thus, typically, when the temperature of recirculated scrubbing fluid is greater than the temperature of virgin scrubbing fluid entering the wet scrubber, the optimum position of the distribution plate arranged to distribute recirculated scrubbing fluid is lower within the scrubbing vessel.

For the avoidance of doubt, all aspects described hereinbefore may be combined mutatis mutandis.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Preferred features of the present invention will now be described, by way of example, with reference to the accompanying drawings, in which:

FIG. 1 shows a cutaway view of a wet scrubber.

FIG. 2 shows cross sectional view of a wet scrubber.

FIG. 3 shows a sectional view of part of a wet scrubber comprising a distribution plate.

FIG. 4 illustrates recirculating water flow rate of a first example.

FIG. 5 illustrates optimum distribution plate position of another example.

FIG. 6 illustrates optimum distribution plate position of a further example.

FIG. 7 illustrates the effects of increased fresh water and recirculated water temperature of another example.

FIG. 8 illustrates the effects of temperature change of fresh water and recirculated water independently of another example.

FIG. 9 illustrates optimum distribution plate position in relation to recirculating water temperature with fresh water at 7° C. of a further example.

FIG. 10 illustrates ammonia concentration output in a further example.

FIG. 11 illustrates the effects of fresh water flow rate of another example.

FIG. 12 illustrates the effects on ammonia output concentration in relation to ammonia flow rate with and without recirculating water in a further example.

FIG. 13 illustrates the effects of changing flow rates in scrubbing vessels of two different diameters in a further example.

FIG. 14 illustrates the effects of the position of a distribution plate when using fresh water only and recirculated water only in a wet scrubber of another example.

FIG. 15 illustrates the effects of using fresh water and recirculated water together in a wet scrubber of another example.

FIG. 16 illustrates the effects of using fresh water and recirculated water together in a wet scrubber of another example.

FIG. 17 illustrates the optimum position of a distribution plate arranged to distribute recirculated scrubbing fluid of a further example.

FIG. 18 illustrations the throat diameter of a venturi scrubber.

### DETAILED DESCRIPTION

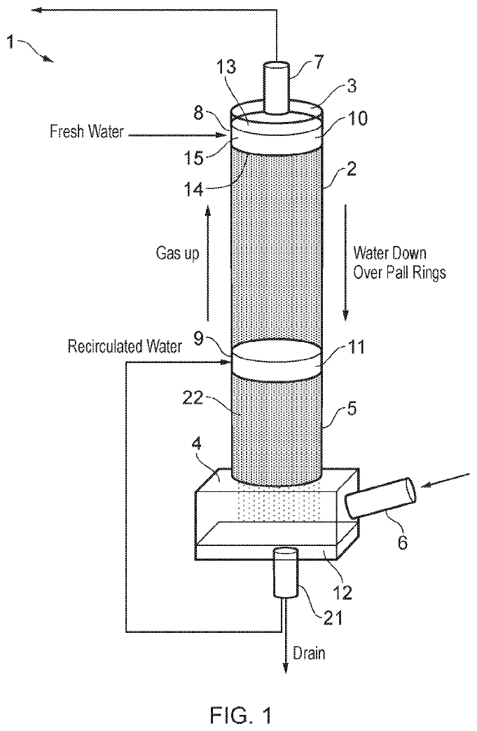

FIG. 1 shows a cutaway view of a wet scrubber 1 according to the present invention. The wet scrubber 1 is arranged to scrub one or more components of an incoming gas stream from the gas stream as part of a gas abatement process. For example, the wet scrubber 1 may be configured to scrub ammonia from an incoming gas stream.

The wet scrubber 1 comprises a scrubbing vessel 2 defining a chamber. The scrubbing vessel 2 is an upwardly extending cylinder having a top end 3, a bottom end 4 and a circumferential wall 5. The scrubbing vessel 2 is a packed scrubbing vessel containing a plurality of pall rings 22 which increase the total surface area of the chamber.

The wet scrubber 1 further comprises a gas inlet 6 and a gas outlet 7. The gas inlet 6 is configured to supply a gas to be scrubbed into the chamber. The gas outlet 7 is configured to allow the exit of a scrubbed gas from the chamber once the gas has been treated. The gas inlet 6 and gas outlet 7 are in fluid communication with one another and with the chamber of the scrubbing vessel 2.

The gas inlet 6 is located towards the bottom end 4 of the scrubbing vessel 2, wherein a gas to be scrubbed will travel generally upwards within the chamber, towards the gas outlet 7. The gas outlet 7 is located at the top end 3 of the scrubbing vessel 2.

The wet scrubber 1 further comprises two scrubbing fluid supply ports 8, 9. The scrubbing fluid supply ports 8, 9 provide a scrubbing fluid, for example water, into the chamber of the scrubbing vessel 2. In the embodiment of FIG. 1, the first supply port 8 is configured to supply fresh, unused scrubbing fluid to the scrubbing vessel 2. The second supply port 9 is configured to supply recirculated scrubbing fluid to the scrubbing vessel 2. The wet scrubber 1 further comprises a reservoir 12 located beneath the scrubbing vessel 2 which is arranged to collect scrubbing fluid.

The wet scrubber 1 further comprises first and second distribution elements 10, 11. The distribution elements 10, 11 are distribution plates. The first distribution plate 10 is located towards the top end 3 of the scrubbing vessel 2. The second distribution plate 11 is located in the bottom half of the scrubbing vessel 2, and is located approximately in the lowermost third of the scrubbing vessel 2.

Each distribution plate 10, 11 is arranged to allow fluid to flow across said distribution plate. In other words, fluid may flow between the gas inlet 6 and the gas outlet 7, across each distribution plate. In use, gas flows across the first and second distribution plates 10, 11 towards the gas outlet 7. Scrubbing fluid from the first distribution plate 10 flows across the second distribution plate 11 towards the reservoir 12. The distribution plates 10, 11 are described in greater detail below.

The first distribution plate 10 is configured to distribute fresh, unused water from supplied via a first scrubbing fluid supply port 8. Fresh water is therefore distributed, in use, from the top end of the scrubbing vessel 2 by the first distribution plate 10. The second distribution plate 11 is configured to distribute recirculated water, which has already passed through the scrubbing vessel 2 and has been collected in the reservoir 12. Recirculated scrubbing fluid is supplied to the second distribution plate 11 via a second scrubbing fluid supply port 9.

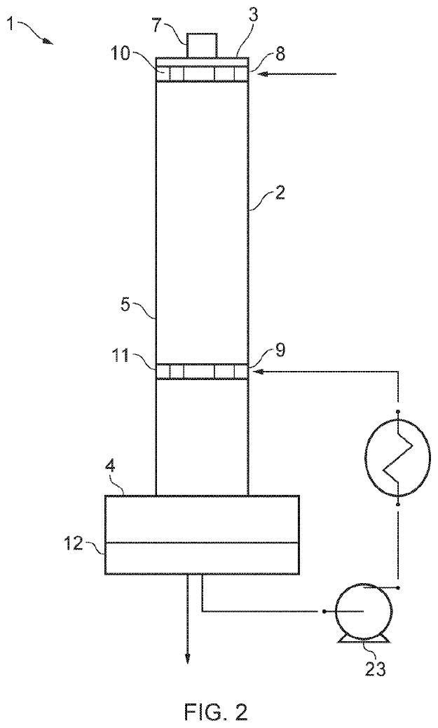

Referring to FIG. 2, the wet scrubber 1 comprises a pump 23 for recirculating water collected in the reservoir 12 and supplying the water to the second distribution plate 11. The wet scrubber 1 further comprises a heat exchanger for controlling the temperature of scrubbing fluid which is recirculated into the scrubbing vessel 2.

Each distribution plate 10, 11 is contacted by packing material within the scrubbing vessel 2. A bottom surface of the first distribution plate 10 is in contact with packing material. Top and bottom surfaces of the second distribution plate 11 are in contact with the packing material. The second distribution plate 11 is therefore substantially bounded by packing material within the scrubbing vessel 2.

Referring back to FIG. 1, the general flow of fluids into and within the wet scrubber 1 during use is shown. A gas stream is supplied to the wet scrubber 1 via the gas inlet 6. In the embodiment of FIG. 1, the gas inlet 6 is arranged to feed a gas into a region of the wet scrubber 1 housing the reservoir 12. Scrubbing fluid, in the form of fresh water at the first distribution plate 10 and recirculated water at the second distribution plate 11, is forced into the scrubbing vessel 2. In use, scrubbing fluid flows from each distribution plate 10, 11 and downwards through the packing material 22. The configuration of the distribution plates 10, 11 and packing material 22 provides substantially even distribution of scrubbing fluid within the scrubbing vessel 2. Scrubbing fluid therefore flows counter currently to the gas to be scrubbed, which generally flows from the gas inlet 6 and upwards towards the gas outlet 7. Gas therefore comes into contact with recirculated water and/or a mixture of recirculated and fresh water before flowing across the second distribution plate 11. Gas subsequently comes into contact with only fresh water once it has passed the second distribution plate 11 and flows towards the first distribution plate 10 and towards the gas outlet 7.

The reservoir 12 comprises a drain 21 which is configured to allow scrubbing fluid to exit the wet scrubber 1. During use, scrubbing fluid is supplied and recirculated within the scrubbing vessel 2 and the scrubbing fluid eventually becomes saturated with the component of the gas to be scrubbed and is drained from the wet scrubber 1.

In the embodiment of FIG. 1, the scrubbing vessel is approximately 910 mm in height. The wet scrubber 1 is configured to scrub ammonia from an incoming gas stream. The second distribution plate 11 is optimally located around 253 mm from the bottom of the scrubbing vessel 2 when the following conditions are provided: 14 litres per minute of ammonia in 150 litres per minute of dilution nitrogen are supplied via the gas inlet 6; 120 litres per hour of fresh water at approximately 7° C. is supplied to the first distribution plate 10; and 150 litres per hour of recirculated water at approximately 9° C. is supplied to the second distribution plate 11. The scrubbing vessel 2 comprises approximately 557 mm of packing between the first and second distribution plates, and approximately 258 mm of packing below the second distribution plate. The optimal position of the second distribution plate 11 would be lower if the temperature of the recirculated water were to be greater in relation to the fresh water supplied by the first distribution plate 10. In this embodiment, the second distribution plate 10 reduces the ammonia gas output concentration from approximately 300 ppm to less than 150 ppm compared to a wet scrubber 1 devoid of a second distribution plate 11 supplying recirculated water.

The present inventors have found that the following variables do not results in changes to the optimum position of the second distribution plate: total column height; fresh water flow rate into the first distribution plate; ammonia flow rate; and dilution nitrogen flow rate. The present inventors have also found that the following variables do result in changes to the optimum position of the second distribution plate: the temperature of the second distribution plate in relation to fresh water temperature flowing from the first distribution plate; and column diameter.

Additionally, or alternatively, the wet scrubber may be configured to remove or reduce the amount of one or more compounds associated with epitaxial silicon growth, for example dichlorosilane (SiCl₂H₂), trichlorosilane (SiCl₃H) and/or hydrogen chloride (HCl), from a process gas.

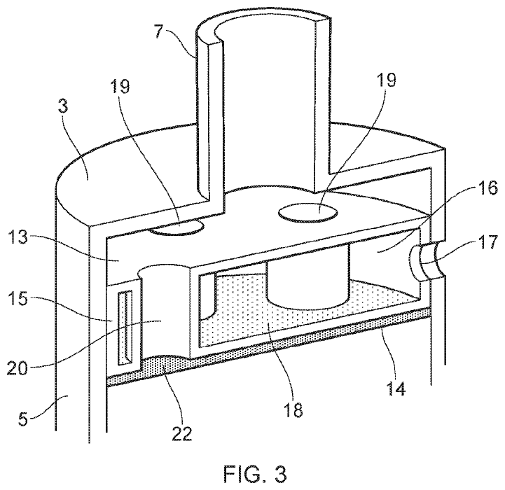

FIG. 3 shows a sectional view of part of a wet scrubber 1 comprising a distribution plate 10. Part of the scrubbing vessel 2 and the gas outlet 7 are shown.

The scrubbing vessel 2 is substantially cylindrical. The gas outlet 7 is formed as a substantially cylindrical duct which extends vertically away from the scrubbing vessel.

The distribution plate 10 comprises a top surface 13, a bottom surface 14 and a circumferential wall 15 which extends between the top 13 and bottom 14 surfaces to define a cavity 16. The distribution plate 10 comprises a conduit 17 which is arranged to be in fluid communication with a fluid supply port 8 of the scrubbing vessel 2. The distribution plate 10 fits within the scrubbing vessel 2 such that there is substantially no gap between the circumferential wall of the distribution plate 10 and the inner surface of the scrubbing vessel 2.

The distribution plate 10 further comprises a plurality of apertures 18 which are substantially uniformly spaced across the bottom surface 14 and are arranged to allow scrubbing fluid to flow from the cavity.

The distribution plate further comprises several channels 19 which extend between the top 13 and bottom 14 surfaces and are arranged to allow fluid to pass therethrough. Each channel 19 has a substantially cylindrical axial cross section. Each channel 19 comprises a separating wall 20 which separates the channel from the cavity 16. Thus, scrubbing fluid cannot flow from the cavity into the channel, and gas which is flowing towards the gas outlet 7, in use, cannot enter the cavity 16.

The distribution plate 10 has a height which is sufficient to allow the cavity to cope with a rate of flow of scrubbing fluid entering the cavity 16 from the scrubbing fluid supply port 8. In the embodiment of FIG. 3, the distribution plate has a height of approximately 50 mm and a diameter of approximately 115 mm. The distribution plate 10 comprises five channels 19 which each have a diameter of approximately 18 mm. The channels 19 are uniformly spaced across the dimeter of the distribution plate 10. The cavity 16 is fed scrubbing fluid via a ⅜″ bulkhead water supply connection at the fluid supply port 8. Each of the apertures 18 of the distribution plate 10 are approximately 1.2 mm in diameter. In the embodiment of FIG. 3, the bottom surface 14 of the distribution plate 10 comprises 88 apertures which are relatively uniformly spaced across the bottom surface 14.

The scrubbing vessel 2 is packed with pall rings 22 which are contiguous with the distribution plate 10.

The wet scrubber 1 may be used in the wet side of an abatement system, downstream of a combustor.

The wet scrubber 1 and each distribution plate comprises polypropylene.

### EXAMPLES

### Example 1—Water Carryover

The present inventors have found that there is significantly less water carryover in a wet scrubber according to the present invention in contrast to a known wet scrubber comprising only a spray nozzle. Water carryover in wet scrubbers comprising i) a spray nozzle in accordance with a known wet scrubber, and ii) a second distribution plate arranged to distribute recirculated scrubbing fluid is shown in Table 1.

TABLE 1

| | | | Water | | | |
|---|---|---|---|---|---|---|
| | Water | | Vapour | FTIR | Standard | Mist |
| | Temperature | Theoretical | Measured | sample | Deviation | Carryover |
| Type | (° C.) | Water Vapour | by FTIR | size | (%) | (%) |
| Spray Nozzle | 7.43 | 1.02% | 1.91% | 54 | 9.73% | 87.11% |
| Distribution | 7.34 | 1.01% | 0.84% | 127 | 0.71% | −17.33% |
| Plate | | | | | | |

Table 1 shows that a cyclone mechanism may not be required if a distribution plate arranged to distribute recirculated scrubbing fluid is used. Therefore, the volume of a scrubbing vessel saved by not requiring a cyclone can allow additional packing material within the scrubbing vessel, and thus increase the scrubbing capacity within a scrubbing vessel having the same volume. Theoretical water vapour in Table 1 is provided using the Antoine Equation.

The first distribution plate has the advantage of reduced water carryover and therefore a cyclone is not required in embodiments of the present invention. However, if a cyclone were to be sized appropriately, and having a high gas velocity, they may be able to remove particulate entrained in the gas phase. A higher inlet velocity to a cyclone increases the efficiency and allows a smaller size of particle to be removed. An optimum inlet velocity is determined to be around 9 metres per second. It has been found that the efficiency of a cyclone may drop off at an inlet velocity of 17 metres per second, and that the pressure drop will increase significantly from 9 metres per second to 17 metres per second. At this size, the cyclone would be able to be fit within the channels of the distribution plate. Thus, additional function could be achieved without compromising space within a wet scrubber. Additionally, if very high gas flow rates were used there may be the possibility of water carryover. In this instance, the addition of one or more cyclones within the channels of the distribution plates could allow the water carryover to be reduced without increased space requirements.

### Example 2—Distribution Plate Distributing Recirculating Water

In a wet scrubber as described above, fresh water is supplied to a first distribution plate located towards the top end of a scrubbing vessel at 7 to 8° C. and 0.8 to 1 bar.

Unless stated otherwise, the following conditions were put in place: a scrubbing vessel column height of 910 mm; a column inner diameter of 115 mm; packing comprising 16 mm polypropylene pall rings; a packing height of 810 mm; an ammonia supply at 14 lpm; a dilution nitrogen supply at 150 lpm; fresh water flow rate at the first distribution plate of 120 lph; a fresh water temperature of 7° C.; a recirculating water flow rate at the second distribution plate of 150 lph; and a recirculating water temperature of 9° C.

The water drains into the reservoir at the bottom of the wet scrubber. This water contains dissolved ammonia. Some of the water is collected and pumped and passed through a heat exchanger before flowing through a second distribution plate arranged to distribute recirculated scrubbing fluid in the lower half of the scrubbing vessel. The recirculated water is at 9° C. as it enters the packed scrubbing vessel.

The second distribution plate in the lower half of the scrubbing vessel allows the water coming down from the first distribution plate to pass through the channels of the second distribution plate and then mix with the recirculated water beneath the second distribution plate. The channels are large enough to avoid a high pressure drop or blockage, and small enough that the majority of the distribution plate surface comprises apertures for even distribution of scrubbing fluid.

The position of the second distribution plate is important for the performance of the wet scrubber, as is the flow rate of recirculated scrubbing fluid into the second distribution plate. If the second distribution plate is positioned too low within the scrubbing vessel, the recirculated water is, in use, flowing over less packing material and so has less time for scrubbing to occur. If the second distribution plate is positioned too high within the scrubbing vessel, the packing material above the second distribution plate is reduced and the fresh water flowing from the first distribution plate has a smaller volume of packing and thus reduced performance. Furthermore, if the second distribution plate is positioned too high within the scrubbing vessel, the vapour pressure of ammonia in the recirculated water will be higher than the concentration of ammonia at the same point if the column was supplying fresh water only.

The recirculating water flow rate should not be so high that flooding occurs. If should be high enough that there is a large gas-liquid contact area. The liquid in the lower half of the column is a mixture of the lower concentration ‘fresh’ water flowing from the first distribution plate and the more concentrated recirculated water flowing from the second distribution plate. Therefore, the higher the recirculating flow rate, the greater the concentration of the mixture of the liquids in the lower half of the scrubbing vessel and therefore the higher the vapour pressure.

Therefore, an optimum flow rate must be determined bearing in mind gas capture and vapour pressure.

In this example, the column of a scrubbing vessel has an outer diameter of 125 mm and an inner diameter of 115 mm, and a height of 910 mm. The first and second distribution plates each have a height of 50 mm. Therefore, the packing material has a total height of 810 mm when both distribution plates are installed.

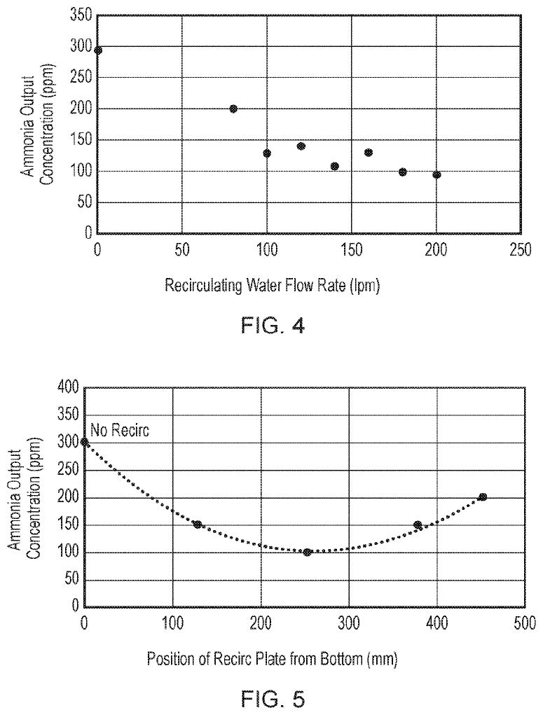

With the second distribution plate installed 125 mm from the bottom of the scrubbing vessel, the performance increases as the recirculated water flow rate increases. The observed improvement plateaus around 150 litres per hour. The results are shown at FIG. 4.

### Example 3a—Position of Recirculating Distribution Plate

The second distribution plate was tested in a range of positions from the bottom of a scrubbing vessel. The distribution plate was tested at 128 mm, 253 mm, 378 mm and 435 mm from the bottom of a scrubbing vessel 910 mm in height. This left 682 mm, 557 mm, 432 mm and 357 mm of packing respectively above the second distribution plate and below a first distribution plate. The flow rate of ammonia and dilution nitrogen into the wet scrubber were 14 lpm and 150 lpm respectively; 120 lph of fresh water at around 7° C. was supplied to the first distribution plate located at the top end of the scrubbing vessel, and 150 lph of recirculated water at around 9° C. was supplied to the second distribution plate at it's various positions. The results are shown at FIG. 5.

Of the positions tested, the optimum position for the second distribution plate was 253 mm from the bottom of the scrubbing vessel.

### Example 3b—Position of Recirculating Distribution Plate in Relation to Height of Column and Distribution Plates

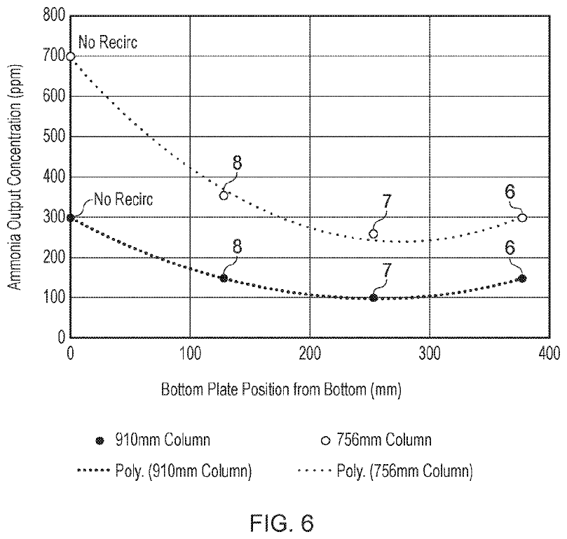

As shown in FIG. 6, if the height of the scrubbing vessel is reduced from 910 mm to 756 mm, the optimum position of the second distribution plate remains the same.

The present inventors have also found that the optimum position would be the same if the distribution plates were less than 50 mm in height, allowing more packing material to be placed within the scrubbing vessel.

An output concentration of ammonia is reduced from 300 ppm to less than 150 ppm when the second distribution plate is installed at a position between 125 mm and 358 mm from the bottom of the scrubbing vessel column. The improvement results in reduced nitrous oxide formation in downstream abatement systems without having to increase fresh water flow rate, increase the height of the scrubbing vessel, decrease the temperature of the scrubbing water, increasing the column diameter, or decreasing the dilution nitrogen.

### Example 5—Temperature

A change in temperature of recirculated water supplied by a second distribution plate relative to the temperature of fresh water supplied by a first distribution plate results in a change of optimum position of the second distribution plate.

If the recirculating water temperature is increase relative to the fresh water temperature, the recirculated water supplied by the second distribution plate removes a smaller amount of ammonia from the gas phase. This is because the ammonia vapour pressure is higher at a higher temperature. Therefore, when the recirculating water temperature increases relative to the fresh water temperature, the optimum position of the second distribution plate is lower in the column. The performance of the wet scrubber also decreases with an increase in temperature of the recirculated water.

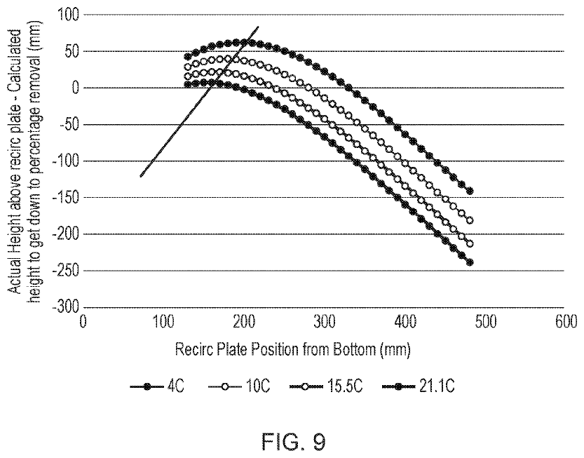

If both the fresh water and recirculating water increase in temperature, the improvement from adding the second distribution plate remains as both the fresh water and recirculating water will be affected equally by the same temperature increase, as shown in FIGS. 8 and 9.

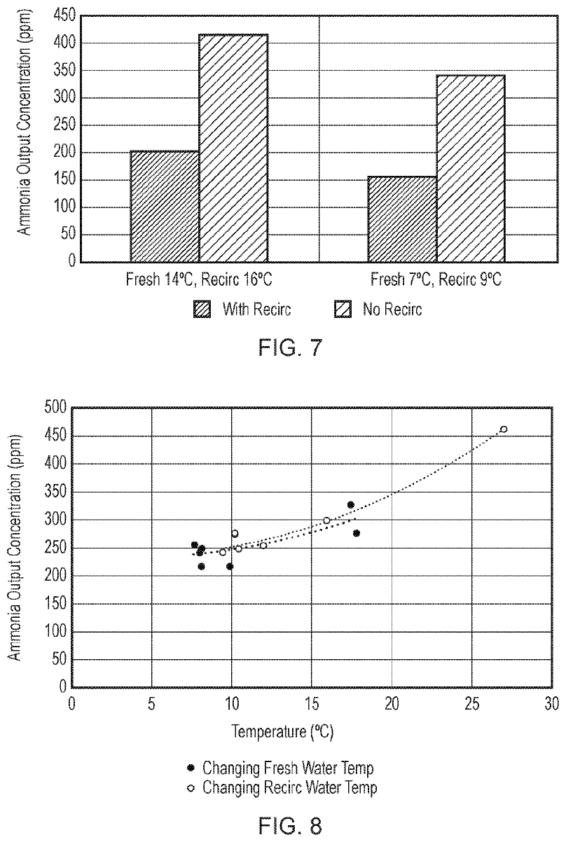

FIG. 7 shows conditions of a second distribution plate height of 253 mm from the bottom of the scrubbing column; a column height of 820 mm; a fresh water flow rate of 120 lph; a recirculating water flow rate of 150 lph; an internal column diameter of 115 mm; and an ammonia flow rate of 14 lpm.

When both the temperature of both the fresh water and recirculated water is increased by 7° C., there is still an approximately 50% improvement over fresh water alone at the higher temperature.

The temperature of the recirculating water may be influenced by: the temperature of the fresh water; the enthalpy of solution of the dissolved ammonia; heat vaporisation of the water vapour within the column; heat from the pump as the water is pumped from a drain tank; the presence of a heat exchanger and its conditions; or ambient air conditions.

The maximum point of each curve shown in FIG. 9 indicates the optimum position for the second distribution plate from the bottom of the scrubbing vessel for temperatures of 4° C., 10° C., 15.5° C. and 21.1° C., when the fresh water temperature flowing from the first distribution plate is 7° C. FIG. 9 shows the optimum position slightly decreases as the temperature increases.

Referring back to FIG. 8, if the recirculating water temperature is increased too high relative to the fresh water temperature there will be no improvement over scrubbing with fresh water alone. FIG. 8 relates to a scrubbing column with a total height of 830 mm and with the second distribution plate positioned 378 mm from the bottom of the column.

### Example 6—Fresh Water

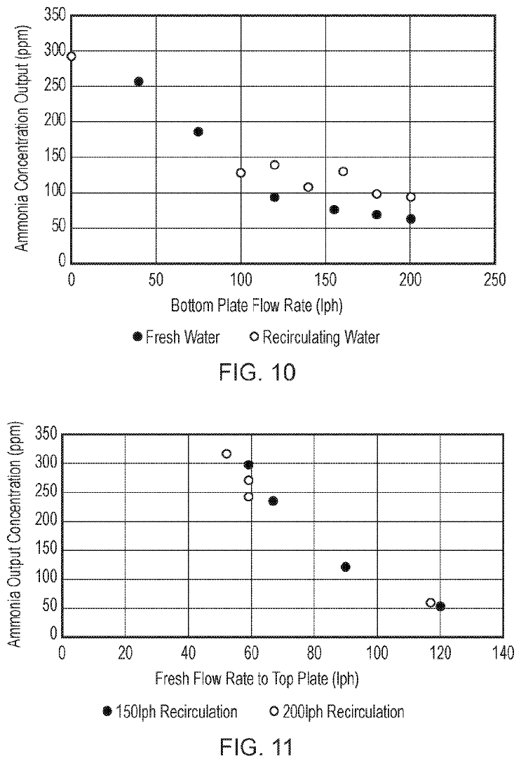

FIG. 10 shows that if fresh water is supplied to both the first and second distribution plates, there is some improvement over supplying fresh water to the first distribution plate and recirculated water to the second distribution plate. This is due to a lower vapour pressure if fresh water is supplied to both distribution plates. However, if fresh water flow is not constrained, the present inventors have found that it is better to supply a higher flow rate to a single distribution plate rather than being split across two plates, as the fresh water can then flow over a greater packing volume and achieve a greater scrubbing rate.

### Example 7—Flow Rate

The effect of reducing the fresh water flow rate whilst keeping the flow rate of the recirculating water constant is shown in FIG. 11. The conditions are as follows: fresh water temperature of 8° C.; a recirculating water temperature of 10° C.; a column height of 910 mm; and an inner diameter of the column of 115 mm.

The addition of recirculating water supplied via the second distribution plate allows the fresh water flow rate to be reduced whilst maintaining performance.

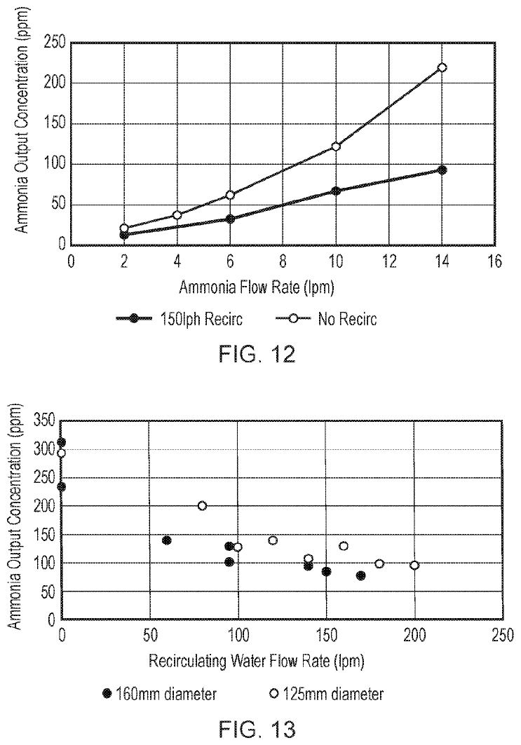

FIG. 12 shows a performance improvement for ammonia flow rates between 2 lpm and 14 lpm at the conditions described above and with a second distribution plate installed at the optimum position described above.

### Example 8—Column Diameter

FIG. 13 shows results of testing 125 mm and 160 mm diameter columns, both having a height of 910 mm, and a recirculating distribution plate at 253 mm from the bottom of the column. There is shown to be some improvement with the larger diameter column.

### Example 9—Comparison of Recirculating and Fresh Distribution as Position in Column Changes

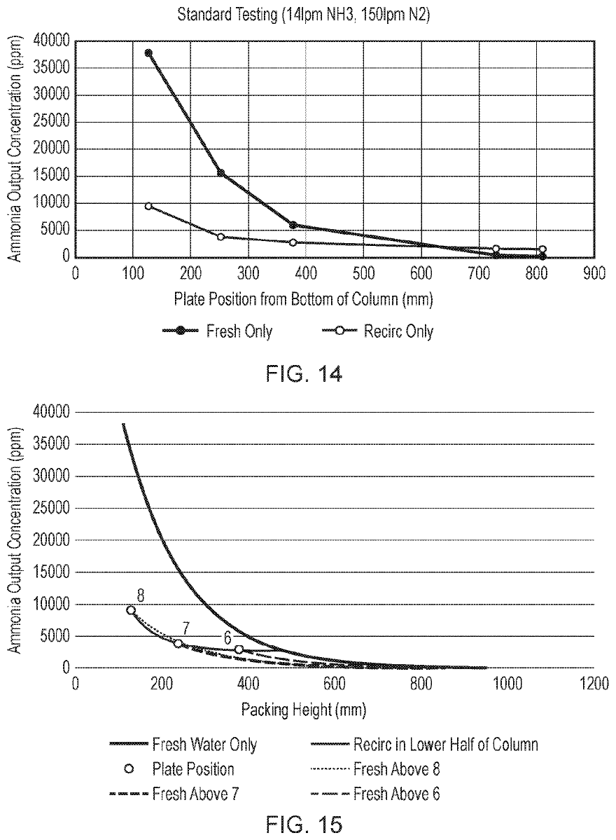

FIG. 14 shows how the recirculating part of the column scrubs as its height up the column increases compared to how fresh water scrubs as the height up the column increases. This assumes there is no fresh water above the recirculating distribution plate. Above 620 mm, the recirculating water performs worse than fresh water. Between 400 mm and 620 mm there would be very little improvement by adding a second distribution plate distributing recirculated water. Below 450 mm there is most difference between recirculated water and fresh water. Therefore, an optimum position for the second distribution plate is somewhere up to 450 mm from the bottom of the column.

FIG. 14 also shows that if the temperature of the recirculated water is increased, the ‘recirc’ line would be higher in FIG. 14 due to the higher vapour pressure. There would be less difference between the fresh water scrubbing and recirculating water scrubbing at the lower plate positions, and the optimum position would be lower in the column for higher temperatures.

If the ammonia or nitrogen flow rate was changed, both lines of FIG. 14 would move up or down similarly, therefore the optimum position would not change substantially under those conditions.

### Example 10—Synergistic Effect of Fresh and Recirculated Water

FIG. 15 shows the concentration of ammonia from the bottom of the column to the top with just fresh water. IT also shows concentration of ammonia with a second distribution plate distribution recirculated water from positions between 130 mm and 500 mm with positions 8, 7 and 6 labelled. Positions 8, 7 and 6 represent 125 mm, 253 mm and 378 mm from the bottom of the column respectively.

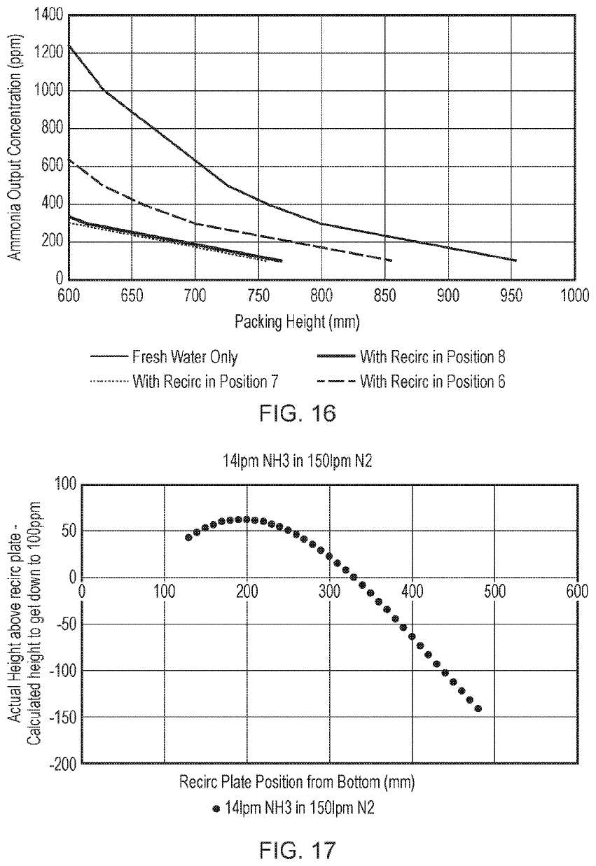

From each if the concentrations at positions 8, 7 and 6 the dashed lines show how the fresh water height above the second distribution plate is able to decrease the ammonia concentration further. FIG. 16 shows the top of the column and the heights that would be required to reduce the ammonia output to 100 ppm. With the second distribution plate in position 7, the smallest height required to achieve 100 ppm, that can therefore be assumed to be the optimum position by calculation.

Using this method, a full range of heights may be calculated. This is shown in FIG. 17. The Y-axis represents the height remaining in the column subtracted from the theoretical height required to achieve 100 ppm. Therefore, the higher the value the better the position. It shows 200 mm from the bottom of the column as the optimum theoretical position. Differences between the calculated and measured positions are attributed to variation in mixing and flow distribution at the point where the two flow rates mix, as well as temperature variations and the like.

### Example 11—Venturi Scrubber

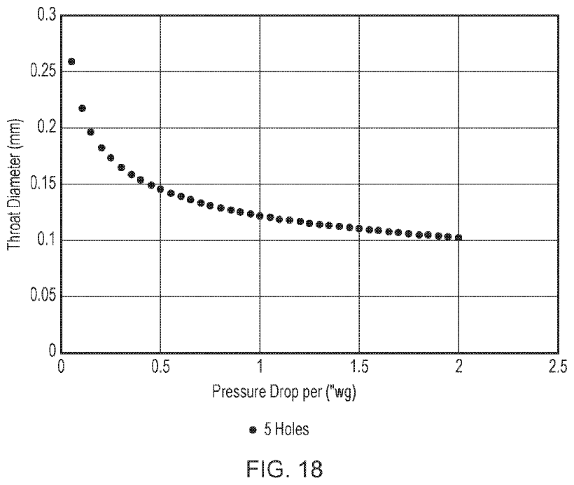

FIG. 18 shows how the throat diameter of the venturi scrubber depends on the pressure drop suitable for the process and gas flow rate. There is an optimum liquid gas ratio for a venturi scrubber of approximately 10 gal/1000 ft³. In embodiments, 150 litres per minutes of gas is split between five pathways, 0.04 litres per minute of scrubber water would be required per venturi scrubber throat.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A wet scrubber for gas abatement, comprising a scrubbing vessel defining a chamber, a gas inlet for supplying a gas to be scrubbed, and a gas outlet for allowing the egress of a scrubbed gas, the inlet and outlet being in fluid communication with one another;
one or more scrubbing fluid supply ports;
the wet scrubber comprising at least first and second distribution elements each connected to a scrubbing fluid supply port for distributing a scrubbing fluid inside the chamber;
wherein the first distribution element is arranged to distribute virgin scrubbing fluid inside the chamber;
and the second distribution element is arranged to distribute recirculated scrubbing fluid inside the chamber.

2. The wet scrubber according to claim 1, wherein the second distribution element is fluidly located between the first distribution element and the gas inlet.

3. The wet scrubber according to claim 1, wherein at least one distribution element comprises a distribution plate comprising a cavity and a plurality of apertures arranged to allow scrubbing fluid to flow from the cavity.

4. The wet scrubber according to claim 1, wherein the scrubbing vessel is a substantially vertically extending column; and the second distribution element is located substantially in the lower half of the scrubbing vessel.

5. The wet scrubber according to claim 1 wherein the scrubbing vessel is a substantially vertically extending column; and the second distribution element is located substantially in the lowermost third of the scrubbing vessel.

6. A wet scrubber for gas abatement, comprising a scrubbing vessel defining a chamber, a gas inlet for supplying a gas to be scrubbed, and a gas outlet for allowing the egress of a scrubbed gas; the inlet and outlet being in fluid communication with one another;
one or more scrubbing fluid supply ports;
the wet scrubber comprising at least one distribution element connected to a scrubbing fluid supply port for distributing a scrubbing fluid inside the chamber;
wherein at least one said distribution element is a distribution plate comprising a cavity and a plurality of apertures arranged to allow scrubbing fluid to flow from the cavity.

7. The wet scrubber according to claim 6, comprising first and second distribution elements; wherein the first and second distribution elements are distribution plates.

8. The wet scrubber according to claim 6, wherein the apertures of the or each distribution plate are substantially uniformly spaced across the bottom surface of said distribution plate.

9. The wet scrubber according to claim 6, wherein the scrubbing vessel contains packing material; and the packing material is substantially contiguous with at least one distribution plate; preferably the packing material is substantially contiguous with each distribution plate.

10. A distribution plate for a wet scrubber, the distribution plate comprising a top surface, a bottom surface and a circumferential wall connecting the top and bottom surfaces and defining a cavity;
the circumferential wall comprising a conduit arranged to be in fluid communication with a scrubbing fluid supply port of a wet scrubber;
the distribution plate further comprising one or more channels extending between the top and bottom surfaces; wherein the or each channel is arranged to allow, in use, fluid to pass therethrough from the top surface towards the bottom surface and vice versa;
the bottom surface comprising a plurality of apertures arranged to allow a scrubbing fluid to flow from the cavity.

11. The distribution plate according to claim 10, wherein the or each channel is bounded by a separating wall which is configured to separate said channel from the cavity.

12. The distribution plate according to claim 10, wherein at least one said channel comprises a venturi scrubber.

13. A method of scrubbing a gas, comprising the steps of:
a. directing a gas to be scrubbed into a wet scrubber;
b. treating the gas with virgin scrubbing fluid and recirculated scrubbing fluid as the gas passes from a gas inlet towards a gas outlet of the wet scrubber.

14. The method according to claim 13, wherein a gas to be scrubbed is contacted first by recirculated scrubbing fluid or a mixture of recirculated and virgin scrubbing fluids, and subsequently only by virgin scrubbing fluid as the gas passes from a gas inlet towards a gas outlet of the wet scrubber.

15. A method of designing a wet scrubber having a scrubbing vessel defining a chamber, a gas inlet, and a gas outlet, one or more scrubbing fluid supply ports and one or more scrubbing fluid distribution elements, wherein at least one said distribution element is a distribution plate arranged to distribute recirculated scrubbing fluid inside the chamber, the method comprising the steps of:
a. determining the configuration and dimensions of the scrubbing vessel, gas inlet, gas outlet and scrubbing fluid supply ports;
b. determining the content and flow rate of gas to be scrubbed into the gas inlet;
c. determining the content and flow rate of scrubbing fluid through the one or more distribution elements; and
d. arranging the or each distribution plate within the scrubbing vessel such that the output concentration of a contaminant to be scrubbed from the gas is minimised.
